(19) United States
(12) Patent Application Publication
(10) Pub. No.: US 2022/0293023 A1
(43) Pub. Date: Sep. 15, 2022

(54) GAMMA CORRECTION METHOD AND STORAGE MEDIUM

(71) Applicant: KunShan Go-Visionox Opto-Electronics Co., Ltd, Kunshan (CN)

(72) Inventors: Tianzhen ZHOU, Kunshan (CN); Xiaobao ZHANG, Kunshan (CN); Zheng WANG, Kunshan (CN); Xinquan CHEN, Kunshan (CN); Hanfei GAO, Kunshan (CN)

(73) Assignee: KunShan Go-Visionox Opto-Electronics Co., Ltd, Kunshan (CN)

(21) Appl. No.: 17/828,243

(22) Filed: May 31, 2022

Related U.S. Application Data
(63) Continuation of application No. PCT/CN2021/081914, filed on Mar. 19, 2021.

(30) Foreign Application Priority Data
May 8, 2020 (CN) 2020103900939

(51) Int. Cl. G09G 3/00; G09G 3/3208

(52) U.S. Cl. CPC G09G 3/006; G09G 3/3208; G09G 2320/0673; G09G 2360/145

(57) ABSTRACT

A gamma correction method and an apparatus. In the method, RGB adjustment values corresponding to a target binding point are determined through RGB measurement values of a previous binding point of a corresponding target binding point at low-grayscale fault for an OLED module to be corrected, and then voltages of the target binding point are determined according to the RGB measurement values and the RGB adjustment values, and gamma correction is performed on the OLED module to be corrected according to the voltages of the target binding point, resolves the problem of low-grayscale fault caused in terms of the low-grayscale binding point correction. Moreover, the correction process of the embodiments of the present application is simple where a low-grayscale binding point is corrected using the above-mentioned method, and a high-grayscale binding point is automatically adjusted using an optical device, without changing the gamma correction architecture.

### CROSS-REFERENCE TO RELATED APPLICATIONS

The application is a continuation of International Application No. PCT/CN2021/081914, filed on Mar. 19, 2021, which claims priority to Chinese patent application No. 202010390093.9 filed to China National Intellectual Property Administration on May 8, 2020. The disclosures of the aforementioned applications are hereby incorporated by reference in their entireties.

### TECHNICAL FIELD

Embodiments of the present disclosure relate to the field of OLED module detection technologies and, in particular to, a gamma correction method and an apparatus.

### BACKGROUND

The organic light-emitting diode (OLED) is also referred to organic electroluminesence display or organic light-emitting semiconductor. The OLED display technology is advantageous in self-illumination, wide viewing angle, almost infinitely high contrast, low power consumption, and extremely high response speed. The OLED display technology is widely used in mobile phones, digital video cameras, Digital Video Disk (DVD) players, personal digital assistants (PDAs), netbooks, car stereos and televisions. Gamma is derived from the response curve of Cathode Ray Tube (CRT) (display/television), which is a nonlinear relationship between brightness of the CRT (display/television) and input voltage of the CRT (display/television). The gamma curve is a special tone curve. When a gamma value is equal to 1, the curve is a straight line at 45° with a coordinate axis, at this point, the input density and output density are the same. The gamma value higher than 1 will cause the output to be darkened, and the gamma value lower than 1 will cause the output to be brightened.

The gamma correction refers to changing the gamma value to match the intermediate grayscale of the OLED module. The OLED must undergo the gamma correction before leaving the factory, so that the output grayscale brightness curve is consistent with the perception of human eye, that is, conforming to the gamma index curve.

In related gamma correction schemes, fixed assignment (currently 1 or 0) is used for low-grayscale binding point correction. Since the fixed assignment of the screen-body difference is too low, and the grayscale across-voltage is large, the problem of low-grayscale fault will occur when dimming jointly.

### SUMMARY

In order to solve the problems existed in the prior art, the present application provides a gamma correction method and an apparatus.

In order to achieve the foregoing objectives, the embodiments of the present application provide the following technical solutions.

In a first aspect, an embodiment of the present application provides a gamma correction method, which can be executed by a processor. The method includes the following steps: firstly, determining a corresponding target binding point at low-grayscale fault for an OLED module to be corrected according to a preset gamma curve, where the preset gamma curve may be a G2.2 curve, and the OLED module to be corrected can be determined according to actual conditions, which is not particularly limited in the embodiments of the present application; secondly, determining red, green and blue (RGB) adjustment values corresponding to the target binding point according to RGB measurement values of a previous binding point of the target binding point, then determining voltages of the target binding point according to the RGB measurement values and the RGB adjustment values, and performing gamma correction on the OLED module to be corrected according to the voltages of the target binding point. The processor can obtain the RGB measurement values of the previous binding point of the target binding point, that is, actual RGB measurement values of the previous binding point of the target binding point, so as to determine the RGB adjustment values corresponding to the target binding point based on the actual RGB measurement values, so that the gamma correction is performed on the OLED module to be corrected according to the RGB adjustment values corresponding to the target binding point subsequently, thereby resolving the problem of low-grayscale fault caused in terms of the low-grayscale binding point correction.

According to the embodiments of the present application, the RGB adjustment values corresponding to the target binding point are determined through the RGB measurement values and a preset voltage of the previous binding point of the target binding point, and then the voltages of the target binding point are determined according to the RGB measurement values and the RGB adjustment values, and gamma correction is performed on the OLED module to be corrected according to the voltages of the target binding point, thereby solving the problem of low-grayscale fault caused in terms of low-grayscale binding point correction.

In a possible implementation manner, the determining the voltages of the target binding point according to the RGB measurement values and the RGB adjustment values, includes:

calculating differences between the RGB measurement values and the RGB adjustment values;

determining RGB values of the target binding point according to the differences; and

determining the voltages of the target binding point according to the RGB values of the target binding point.

The differences herein are not limited to the use of difference method such as linear difference method, nonlinear difference method, exponential difference method, and function difference method. In the embodiments of the present application, different difference methods can be chosen to be used according to the actual characteristic curve of the screen-body and the performance ability of the actual gamma curve of the subsequent module correction.

In the embodiment of the present application, according to the difference method adopted, the voltages of the target binding point are determined based on the RGB measurement values and the RGB adjustment values, where the difference method can be chosen according to conditions, meeting the needs of a variety of applications.

In a possible implementation manner, the determining the corresponding target binding point at the low-grayscale fault for the OLED module to be corrected according to the preset gamma curve, includes:

determining brightness values of a plurality of binding points corresponding to the OLED module to be corrected according to the preset gamma curve based on the pixel data; and

determining the target binding point according to the brightness values.

Here, an example is taken where the preset gamma curve is the G2.2 curve, the processor determines the brightness values of the plurality of binding points corresponding to the OLED module to be corrected according to the G2.2 curve, and then determines the corresponding target binding point at the low-grayscale fault for the OLED module to be corrected according to the brightness values. The specific number of the binding points may be determined according to actual conditions, for example, 27 binding points, which is not particularly limited in the embodiments of the present application.

In a second aspect, an embodiment of the present application provides a gamma correction apparatus, including:

a first determining module, configured to determine a corresponding target binding point at low-grayscale fault for an OLED module to be corrected according to a preset gamma curve;

a second determining module, configured to determine RGB adjustment values corresponding to the target binding point according to RGB measurement values of a previous binding point of the target binding point;

a third determining module, configured to determine voltages of the target binding point according to the RGB measurement values and the RGB adjustment values;

a correction module, configured to perform gamma correction on the OLED module to be corrected according to the voltages of the target binding point.

The embodiments of the present application provide a gamma correction method and an apparatus. In the method, the RGB adjustment values corresponding to the target binding point are determined through the RGB measurement values of the previous binding point of the corresponding target binding point at the low-grayscale fault for the OLED module to be corrected, and then the voltages of the target binding point are determined according to the RGB measurement values and the RGB adjustment values, and the gamma correction is performed on the OLED module to be corrected according to the voltages of the target binding point, thereby resolving the problem of low-grayscale fault caused in terms of the low-grayscale binding point correction. Moreover, the correction process of the embodiments of the present application is simple where a low-grayscale binding point is corrected using the above-mentioned method, and a high-grayscale binding point is automatically adjusted using an optical device, without changing the gamma correction architecture, which can effectively improve the first pass yield of the production line, reduce the tact time, and meet the requirements of display and large-scale mass production.

### BRIEF DESCRIPTION OF THE DRAWINGS

FIG. 1 is a schematic diagram of a low grayscale fault according to an embodiment of the present application;

FIG. 2 is a schematic diagram of a system architecture of gamma correction according to an embodiment of the present application;

FIG. 3 is a schematic flowchart of a gamma correction method according to an embodiment of the present application;

FIG. 4 is a schematic flowchart of another gamma correction method according to an embodiment of the present application;

FIG. 5 is a schematic flowchart of further gamma correction method according to an embodiment of the present application;

FIG. 6 is a schematic structural diagram of a gamma correction apparatus according to an embodiment of the present application;

FIG. 7 is a schematic structural diagram of another gamma correction apparatus according to an embodiment of the present application;

FIG. 8A is a schematic diagram of a basic hardware architecture of a gamma correction apparatus according to the present application; and

FIG. 8B is a schematic diagram of a basic hardware architecture of another gamma correction apparatus according to the present application.

### DETAILED DESCRIPTION OF THE EMBODIMENTS

The technical solutions in the embodiments of the present application will be described hereunder clearly and comprehensively with reference to the accompanying drawings in the embodiments of the present application. Apparently, the described embodiments are merely a part of embodiments of the present application, rather than all embodiments of the present application. All other embodiments obtained by persons of ordinary skill in the art based on the embodiments of the present application without any creative effort shall fall into the protection scope of the present application.

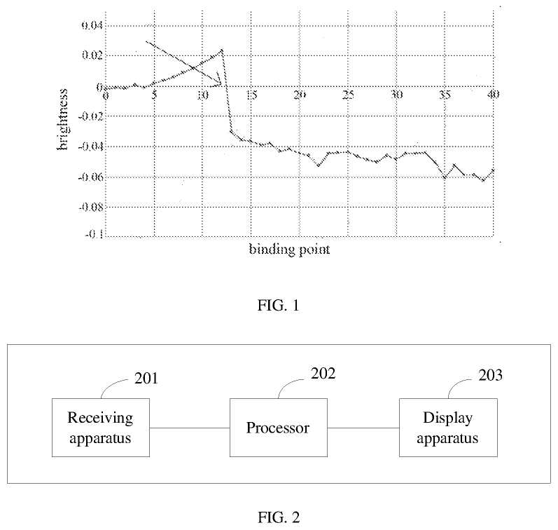

In the gamma correction scheme, with regard to the low-grayscale binding point correction, since the precision for correction optical device is low, and the adjustment requirements cannot be met, the fixed assignment method (currently 1 or 0) is adopted. However, since the fixed assignment of the screen-body difference is too low, and the grayscale across-voltage is large, when dimming jointly, the problem of low-grayscale fault will occur. Exemplarily, the low-grayscale fault is shown in FIG. 1, and a fault appears at the position indicated by the arrow in the figure. In FIG. 1, the abscissa represents the binding point, and the ordinate represents the brightness.

Therefore, the embodiments of the present application propose a gamma correction method, which determines voltages of a target binding point through RGB measurement values of a previous binding point of a corresponding target binding point at low-grayscale fault for an OLED module to be corrected, thereby solving the problem of low-grayscale fault caused in terms of low-grayscale binding point correction through performing gamma correction for the OLED module to be corrected according to the voltages of the target binding point.

The gamma correction method and apparatus provided in the embodiments of the present application can be applied to a liquid crystal module. Further, the liquid crystal module can be used in mobile phones, digital video cameras, DVD players, PDAs, notebooks, car stereos, televisions and the like, which is not limited in the embodiments of the present application.

In an implementation, the gamma correction method and apparatus provided in the embodiments of the present application can be applied to the application scenario as shown in FIG. 2. FIG. 2 merely describes a possible application scenario of the gamma correction method provided in the embodiments of the present application in an exemplary manner, and the application scenario of the gamma correction method provided in the embodiments of the present application is not limited to the application scenario shown in FIG. 2.

FIG. 2 is a schematic diagram of a system architecture of gamma correction. In FIG. 2, an example is taken where the gamma correction is performed for a liquid crystal module when the liquid crystal module leaves the factory. The architecture includes at least one of a receiving apparatus 201, a processor 202, and a display apparatus 203.

It can be understood that the structure illustrated in the embodiments of the present application does not constitute a specific limitation on the gamma correction architecture. In some other feasible implementations of the present application, the architecture may include more or fewer components than those shown in figures, or combine certain components, or split certain components, or arrange different components, which is specifically determined according to the practical application scenario, and not limited herein. The components shown in FIG. 2 can be implemented in hardware, software, or a combination of software and hardware.

In the specific implementation process, the receiving apparatus 201 can be an input/output interface or a communication interface, which can be configured to receive information such as a preset gamma curve, and RGB measurement values of the previous binding point of the corresponding target binding point at low-grayscale fault for the OLED module to be corrected.

The processor 202 can determine, when an OLED module leaves a factory, the voltages of the target binding point, with the RGB measurement values of the previous binding point of the corresponding target binding point at low-grayscale fault for the OLED module to be corrected, and perform gamma correction on the OLED module to be corrected according to the voltages of the target binding point.

The display apparatus 203 can be used to display the RGB measurement values, correction result, and the like.

The display apparatus may also be a touch screen, which is configured to receive instructions of a user while displaying the aforementioned content, so as to implement the interaction with the user.

It should be understood that the processor may be implemented by a way in which the processor reads and executes instructions in a memory, or may be implemented by a chip circuit.

Furthermore, the network architecture and business scenarios described in the embodiments of the present application are intended to illustrate the technical solutions of the embodiments of the present application more clearly, and do not constitute a limitation on the technical solutions provided in the embodiments of the present application. Those of ordinary skill in the art can know that with the evolution of the network architecture and the emergence of new business scenarios, the technical solutions provided in the embodiments of the present application are equally applicable to similar technical problems.

The gamma correction method provided in the embodiments of the present application will be introduced in detail below with reference to the accompanying drawings. The execution subject of the method may be the processor 202 in FIG. 2. The workflow of the processor 202 mainly includes a determination phase and a correction phase. In the determination phase, the processor 202 determines the voltages of the target binding point with the RGB measurement values of the previous binding point of the corresponding target binding point at low-grayscale fault for the OLED module to be corrected. In the correction stage, the processor 202 performs gamma correction for the OLED module to be corrected according to the voltages of the target binding point, so as to solve the problem of low-grayscale fault caused in terms of the correction of the low-grayscale binding point.

The technical solutions of the present application are described below with several embodiments as examples. The same or similar concepts or processes will not be repeated in some embodiments.

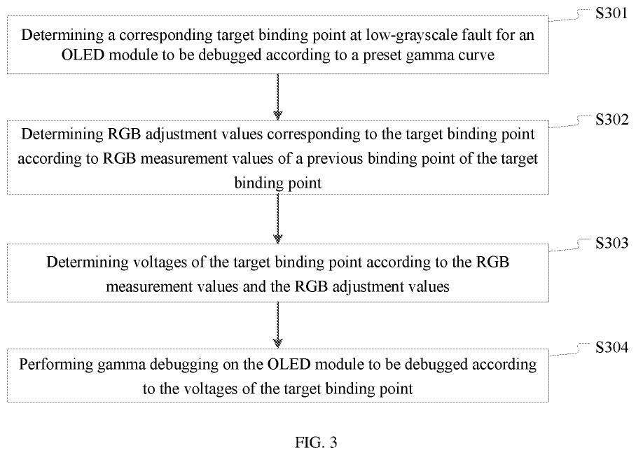

FIG. 3 is a schematic flowchart of a gamma correction method according to an embodiment of the present application. The execution subject of the present application may be the processor 202 in FIG. 2, and the specific execution subject can be determined according to the practical scenario. As shown in FIG. 3, on the basis of the application scenario shown in FIG. 2, the gamma correction method provided by the embodiment of the present application includes the following steps.

S301, determining a corresponding target binding point at low-grayscale fault for an OLED module to be corrected according to a preset gamma curve.

Where the preset gamma curve may be a G2.2 curve, and the OLED module to be corrected may be determined according to actual conditions, which is not particularly limited in the embodiment of the present application.

Here, before the determining the corresponding target binding point at the low-grayscale fault for the OLED module to be corrected according to the preset gamma curve, the gamma correction method further includes:

obtaining brightness data of the OLED module to be corrected; and

converting the brightness data into pixel data.

The brightness data can be understood as the light intensity emitted by a unit area of the OLED module to be corrected.

In the embodiment of the present application, an example is taken for explanation where the execution subject is the processor 202 in FIG. 2. The processor can collect the brightness data of the OLED module to be corrected through a camera, so as to obtain the brightness data of the OLED module to be corrected. Besides, the processor can also obtain the brightness data of the OLED module to be corrected through an external input. The specific acquisition method can be determined according to actual needs, which is not particularly limited in the embodiment of the present application.

After obtaining the brightness data of the OLED module to be corrected, the processor can input the obtained brightness information to a display driver integrated circuit (DDIC) to be internally converted into the pixel data by the DDIC.

Further, after converting the obtained brightness data into the pixel data, the processor can also determine brightness values of a plurality of binding points corresponding to the OLED module to be corrected based on the pixel data according to the gamma curve, and then determine the corresponding target binding point at low-grayscale fault for the OLED module to be corrected according to the brightness values.

Here, an example is taken where the gamma curve is the G2.2 curve, the processor determines the brightness values of the plurality of binding points corresponding to the OLED module to be corrected according to the G2.2 curve, where the specific number of the binding points can be determined according to actual conditions, for example, 27 binding points, which is not particularly limited in the embodiment of the present application.

S302, determining RGB adjustment values corresponding to the target binding point according to RGB measurement values of a previous binding point of the target binding point.

S303, determining voltages of the target binding point according to the RGB measurement values and the RGB adjustment values.

The processor can obtain the RGB measurement values of the previous binding point of the target binding point, that is, the actual RGB measurement values of the previous binding point of the target binding point, so as to determine the RGB adjustment values corresponding to the target binding point based on the actual RGB measurement values, so that the gamma correction is subsequently performed on the OLED module to be corrected according to the RGB adjustment values corresponding to the target binding point, thereby resolving the problem of low-grayscale fault caused in terms of the low-grayscale binding point correction.

S304, performing gamma correction on the OLED module to be corrected according to the voltages of the target binding point.

Exemplarily, the processor can store the voltages in corresponding binding points respectively, so that the DDIC internally performed Source digital-to-analogue conversion (DAC) operation on the voltages, adjust Data voltages of the corresponding binding points, and output to screen-body for completely displaying.

According to the embodiment of the present application, the RGB adjustment values corresponding to the target binding point are determined through the RGB measurement values of the previous binding point of the corresponding target binding point at the low-grayscale fault for the OLED module to be corrected, and then the voltages of the target binding point are determined according to the RGB measurement values and the RGB adjustment values, and the gamma correction is performed on the OLED module to be corrected according to the voltages of the target binding point, thereby resolving the problem of low-grayscale fault caused in terms of the low-grayscale binding point correction. Moreover, the correction process of the embodiment of the present application is simple where a low-grayscale binding point is corrected using the above-mentioned method, and a high-grayscale binding point is automatically adjusted using an optical device, without changing the gamma correction architecture, which can effectively improve the first pass yield of the production line, reduce the tact time, and meet the requirements of display and large-scale mass production.

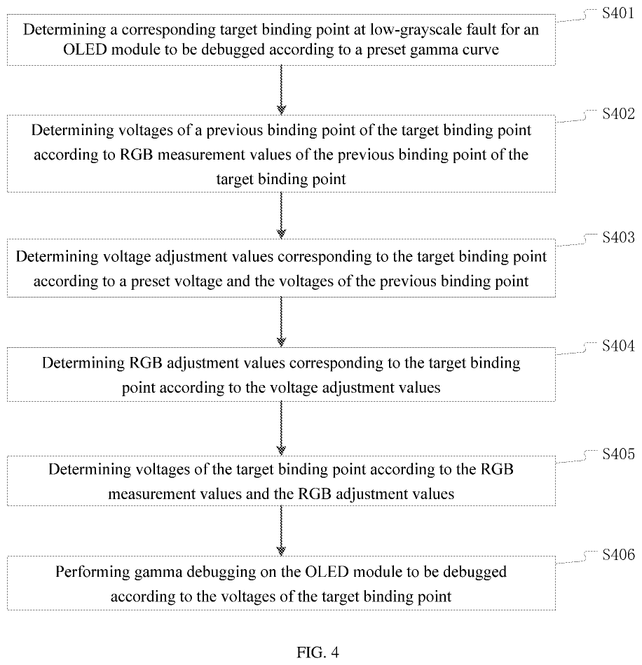

In addition, in the embodiment of the present application, when the RGB adjustment values corresponding to the target binding point are determined, not only the RGB measurement values of the previous binding point of the target binding point is considered, but also the preset voltage is used. FIG. 4 is a schematic flowchart of another gamma correction method according to an embodiment of the present application. As shown in FIG. 4, the method includes:

S401, determining a corresponding target binding point at low-grayscale fault for an OLED module to be corrected according to a preset gamma curve.

The implementation of the step S401 is the same as that of the step S301, which will not be repeated herein.

S402, determining voltages of a previous binding point of the target binding point according to RGB measurement values of the previous binding point of the target binding point.

Here, the processor can convert actual RGB measurement values of the previous binding point of the target binding point into voltage signals respectively, to obtain voltages U_{R}, U_{G}, and U_{B} of the previous binding point of the target binding point.

S403, determining voltage adjustment values corresponding to the target binding point according to a preset voltage and the voltages of the previous binding point.

The preset voltage can be determined according to actual conditions, for example, a maximum voltage required to turn off the OLED module, which is not particularly limited in the embodiment of the present application.

Exemplarily, the determining the voltage adjustment values corresponding to the target binding point according to the preset voltage and the voltages of the previous binding point, includes:

determining voltage adjustment values R_{offset}, G_{offset}, and B_{offset} corresponding to the target binding point according to difference values between the preset voltage and the voltage U_{R}, the voltage U_{G} and, the voltage U_{B} of the previous binding point of the target binding point.

Specifically, according to the following expressions:

R_{offset}=(U_{preset voltage}−U_{R})/step

G_{offset}=(U_{preset voltage}−U_{G})/step

B_{offset}=(U_{preset voltage}−U_{B})/step

the voltage adjustment values R_{offset}, G_{offset} and B_{offset} corresponding to the target binding point is determined, where step represents a grayscale stepping.

S404, determining RGB adjustment values corresponding to the target binding point according to the voltage adjustment values.

In the embodiment of the present application, the processor can convert the voltage adjustment values R_{offset}, G_{offset}, and B_{offset} into RGB values respectively, so as to obtain the RGB adjustment values corresponding to the target binding point.

S405, determining voltages of the target binding point according to the RGB measurement values and the RGB adjustment values.

S406, performing gamma correction on the OLED module to be corrected according to the voltages of the target binding point.

Steps S405-S406 are implemented in the same manner as the foregoing steps S303-S304, which will not be repeated herein.

According to the embodiment of the present application, the RGB adjustment values corresponding to the target binding point are determined through the RGB measurement values and the preset voltage of the previous binding point of the target binding point, and then the voltages of the target binding point are determined according to the RGB measurement values and the RGB adjustment values, and the gamma correction is performed on the OLED module to be corrected according to the voltages of the target binding point, thereby resolving the problem of low-grayscale fault caused in terms of the low-grayscale binding point correction. Moreover, the correction process of the embodiment of the present application is simple where a low-grayscale binding point is corrected using the above-mentioned method, and a high-grayscale binding point is automatically adjusted using an optical device, without changing the gamma correction architecture, which can effectively improve the first pass yield of the production line, reduce the tact time, and meet the requirements of display and large-scale mass production.

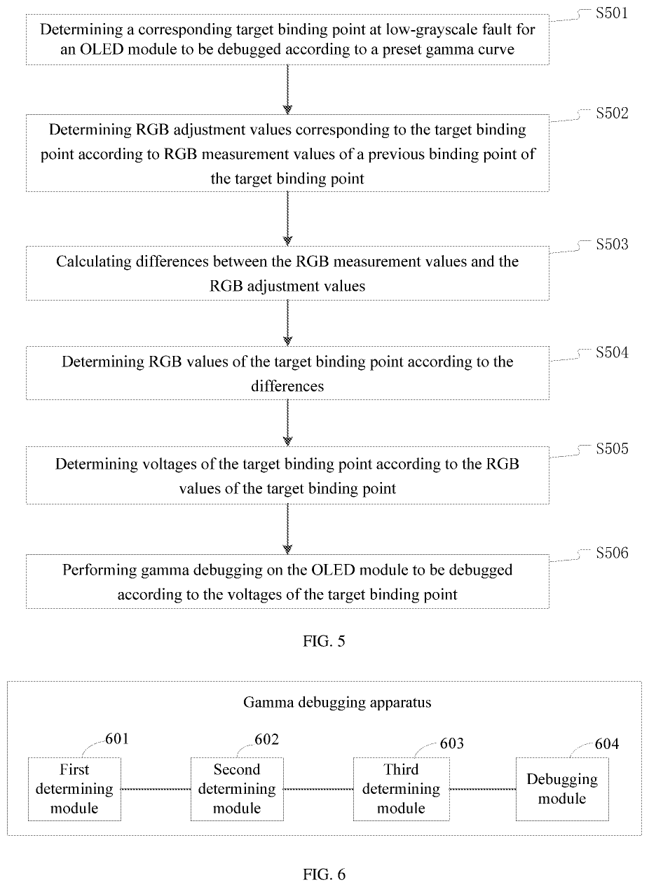

In addition, according to the difference method adopted in the embodiment of the present application, the voltages of the target binding point are determined based on the RGB measurement values and the RGB adjustment values. FIG. 5 is a schematic flowchart of further gamma correction method according to an embodiment of the present application. As shown in FIG. 5, the method includes:

S501, determining a corresponding target binding point at low-grayscale fault for an OLED module to be corrected according to a preset gamma curve.

S502, determining RGB adjustment values corresponding to the target binding point according to RGB measurement values of a previous binding point of the target binding point.

Steps S501-S502 are implemented in the same manner as the foregoing steps S301-S302, which will not be repeated herein.

S503, calculating differences between the RGB measurement values and the RGB adjustment values.

Here, the processor calculates the differences between the RGB measurement values and the voltage adjustment values R_{offset} G_{offset}, and B_{offset} corresponding to the target binding point.

The differences herein are not limited to the use of difference method such as linear difference method, nonlinear difference method, exponential difference method, and function difference method. In the embodiment of the present application, different difference methods can be chosen to be used according to the actual characteristic curve of the screen-body and the performance ability of the actual gamma curve of the subsequent module correction.

S504, determining RGB values of the target binding point according to the differences.

Exemplarily, the processor can use the differences between the RGB measurement values and the voltage adjustment values R_{offset}, G_{offset}, and B_{offset} corresponding to the target binding point as the RGB values of the target binding point.

Specifically, the RGB values Rₙ, Gₙ, and Bₙ of the target binding point can be determined by the following expressions:

Rₙ=Rₙ₊₁(the measurement values of the previous binding point)−R_{offset}

Gₙ=Gₙ₊₁(the measurement values of the previous binding point)−G_{offset}

Bₙ=Bₙ₊₁(the measurement values of the previous binding point)−B_{offset}

S505, determining voltages of the target binding point according to the RGB values of the target binding point.

Here, the processor can convert the RGB values of the target binding point into voltage signals respectively, to obtain the voltages of the target binding point.

S506, performing gamma correction on the OLED module to be corrected according to the voltages of the target binding point.

Step S506 is implemented in the same manner as the foregoing step S304, which will not be repeated herein.

According to the difference method adopted in the embodiment of the present application, the voltages of the target binding point are determined based on the RGB measurement values and the RGB adjustment values, where the difference method can be chosen according to the actual characteristic curve of the screen-body and the performance ability of the actual gamma curve of the subsequent module correction, meeting the needs of a variety of applications. In addition, according to the embodiment of the present application, the RGB adjustment values corresponding to the target binding point are determined through the RGB measurement values of the previous binding point of the corresponding target binding point at the low-grayscale fault for the OLED module to be corrected, and then the voltages of the target binding point are determined according to the RGB measurement values and the RGB adjustment values, and the gamma correction is performed on the OLED module to be corrected according to the voltages of the target binding point, thereby resolving the problem of low-grayscale fault caused in terms of the low-grayscale binding point correction. Moreover, the correction process of the embodiment of the present application is simple where a low-grayscale binding point is corrected using the above-mentioned method, and a high-grayscale binding point is automatically adjusted using an optical device, without changing the gamma correction architecture, which can effectively improve the first pass yield of the production line, reduce the tact time, and meet the requirements of display and large-scale mass production.

Corresponding to the gamma correction method of the embodiment in the above paragraphs, FIG. 6 is a schematic structural diagram of a gamma correction apparatus according to an embodiment of the present application. For ease of description, only the parts related to the embodiment of the present application are shown. The gamma correction apparatus includes: a first determining module 601, a second determining module 602, a third determining module 603, and a correction module 604. The gamma correction apparatus herein can be the processor itself, or a chip or an integrated circuit that implements the functions of the processor. It should be noted herein that the division of the first determining module, the second determining module, the third determining module, and the correction module is only the division of logical functions, and the four modules may be integrated or independent physically.

The first determining module 601 is configured to determine a corresponding target binding point at low-grayscale fault for an OLED module to be corrected according to a preset gamma curve.

The second determining module 602 is configured to determine RGB adjustment values corresponding to the target binding point according to RGB measurement values of a previous binding point of the target binding point.

The third determining module 603 is configured to determine voltages of the target binding point according to the RGB measurement values and the RGB adjustment values.

The correction module 604 is configured to perform gamma correction on the OLED module to be corrected according to the voltages of the target binding point.

The apparatus provided in the embodiment of the present application can be used to implement the technical solution of the foregoing method embodiment, and its implementation principles and technical effects are similar to those of the foregoing method embodiment, which will not be repeated herein.

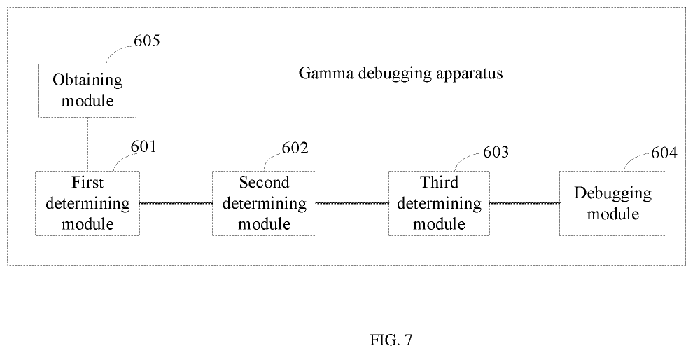

FIG. 7 is a schematic structural diagram of another gamma correction apparatus according to an embodiment of the present application. As shown in FIG. 7, on the basis of the above-mentioned FIG. 6, the gamma correction apparatus further includes: an obtaining module 605.

In a possible implementation manner, the second determining module 602 is specifically configured to:

determine voltages of the previous binding point of the target binding point according to the RGB measurement values;

determine voltage adjustment values corresponding to the target binding point according to a preset voltage and the voltages of the previous binding point; and

determine the RGB adjustment values according to the voltage adjustment values.

In a possible implementation manner, the third determining module 603 is specifically configured to:

calculate differences between the RGB measurement values and the RGB adjustment values;

determine RGB values of the target binding point according to the differences; and

determine the voltages of the target binding point according to the RGB values of the target binding point.

In a possible implementation manner, the obtaining module 605 is configured to obtain brightness data of the OLED module to be corrected before determining, by the first determining module 601, the corresponding target binding point at the low-grayscale fault for the OLED module to be corrected according to the preset gamma curve, and convert the brightness data into pixel data.

In a possible implementation manner, the first determining module 601 is specifically configured to:

determine brightness values of a plurality of binding points corresponding to the OLED module to be corrected according to the preset gamma curve, based on the pixel data; and

determine the target binding point according to the brightness values.

The apparatus provided in the embodiment of the present application can be used to implement the technical solution of the foregoing method embodiment, and its implementation principles and technical effects are similar to those of the foregoing method embodiment, which will not be repeated herein.

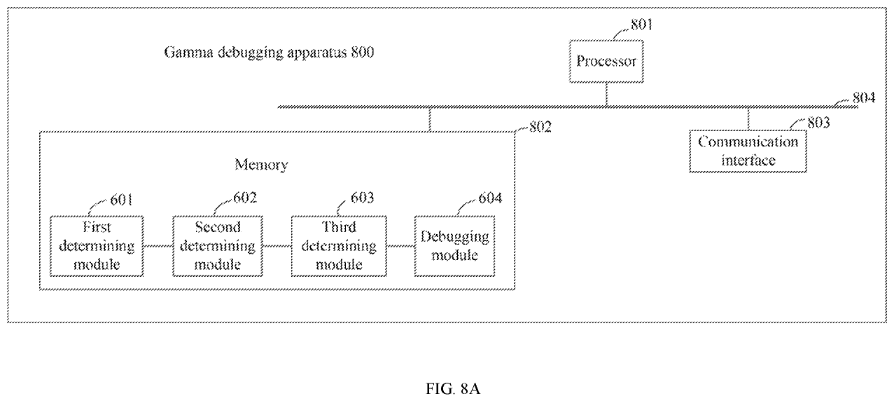

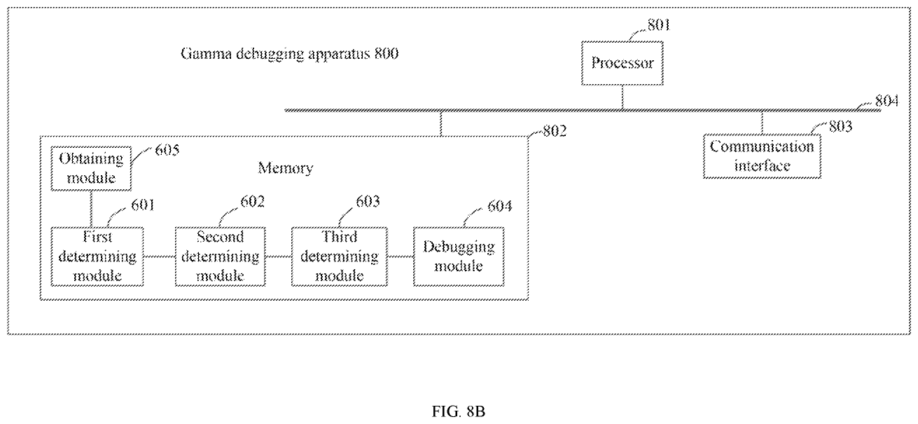

In an implementation, FIGS. 8A and 8B schematically provide a possible basic hardware architecture of the gamma correction apparatus described in the present application.

Referring to FIGS. 8A and 8B, the gamma correction apparatus 800 includes at least one processor 801 and a communication interface 803. In an implementation the apparatus 800 can further includes a memory 802 and a bus 804.

The gamma correction apparatus 800 may be a computer or a server, which is not particularly limited in the present application. In the gamma correction apparatus 800, the number of processors 801 may be one or plural, and FIGS. 8A and 8B only show one processor 801 thereof. In an implementation, the processor 801 may be a central processing unit (CPU), a graphics processing unit (GPU), or a digital signal processor (DSP). If the gamma correction apparatus 800 has a plurality of processors 801, the types of the plurality of processors 801 may be different, or may be the same. In an implementation, the plurality of processors 801 of the gamma correction apparatus 800 may also be integrated into a multi-core processor.

The memory 802 stores therein computer instructions and data; the memory 802 can store computer instructions and data required to implement the gamma correction method provided by the present application, for example, the memory 802 stores instructions for implementing the steps of the gamma correction method. The memory 802 may be any one or a combination of any of the following storage media: non-transitory memory (for example, read-only memory (ROM), solid state disk (SSD), hard disk drive (HDD), optical disc, volatile memory.

The communication interface 803 may provide information input/output for the at least one processor. It may also include any one or any combination of some of the following devices: a network interface (e.g., an Ethernet interface), a device with network access function such as a wireless network card.

In an implementation, the communication interface 803 can also be configured to perform data communication between the gamma correction apparatus 800 and another computing device or a terminal.

In an implementation, the bus 804 is represented by a thick line in FIGS. 8A and 8B. The bus 804 can connect the processor 801 with the memory 802 and the communication interface 803. In this way, the processor 801 can access the memory 802 via the bus 804, and can also perform data interaction with another computing device or a terminal through utilizing the communication interface 803.

In the present application, the gamma correction apparatus 800 executes computer instructions in the memory 802, to cause the gamma correction apparatus 800 to implement the above-mentioned gamma correction method provided in the present application, or to cause the gamma correction apparatus 800 to deploy the above-mentioned gamma correction apparatuses in FIGS. 6 and 7.

From the perspective of logical function division, exemplarily, as shown in FIG. 8A, the memory 802 may include the first determining module 601, the second determining module 602, the third determining module 603, and the correction module 604. When the instructions stored in the memory herein are executed, the functions of the obtaining module and the determining module can be implemented respectively, which is not limited to the physical structure.

The first determining module 601 is configured to determine a corresponding target binding point at low-grayscale fault for an OLED module to be corrected according to a preset gamma curve.

The second determining module 602 is configured to determine RGB adjustment values corresponding to the target binding point according to RGB measurement values of a previous binding point of the target binding point.

The third determining module 603 is configured to determine voltages of the target binding point according to the RGB measurement values and the RGB adjustment values.

The correction module 604 is configured to perform gamma correction on the OLED module to be corrected according to the voltages of the target binding point.

In a possible implementation manner, as shown in FIG. 8B, the memory 802 further includes an obtaining module 605.

In a possible implementation manner, the second determining module 602 is specifically configured to:

determine voltages of the previous binding point of the target binding point according to the RGB measurement values;

determine voltage adjustment values corresponding to the target binding point according to a preset voltage and the voltages of the previous binding point; and

determine the RGB adjustment values according to the voltage adjustment values.

In a possible implementation manner, the third determining module 603 is specifically configured to:

calculate differences between the RGB measurement values and the RGB adjustment values;

determine RGB values of the target binding point according to the differences; and

determine the voltages of the target binding point according to the RGB values of the target binding point.

In a possible implementation manner, the obtaining module 605 is configured to obtain brightness data of the OLED module to be corrected before determining, by the first determining module 601, the corresponding target binding point at the low-grayscale fault for the OLED module to be corrected according to the preset gamma curve, and convert the brightness data into pixel data.

In a possible implementation manner, the first determining module 601 is specifically configured to:

determine brightness values of a plurality of binding points corresponding to the OLED module to be corrected according to the preset gamma curve, based on the pixel data; and

determine the target binding point according to the brightness values.

In addition, the above-mentioned gamma correction apparatus can be implemented through software as shown in FIGS. 8A and 8B, and can also be implemented through hardware as a hardware module or as a circuit unit.

This application provides a computer-readable storage medium, which stores herein a computer program product including computer instructions that instruct a computing device to execute the gamma correction method provided in the present application.

The present application provides a computer program product, which includes computer instructions for causing a computer to execute above-mentioned the gamma correction method.

The present application provides a chip including at least one processor and a communication interface, and the communication interface provides information input and/or output for the at least one processor. Further, the chip may also include at least one memory for storing computer instructions. The at least one processor is configured to call and run the computer instructions to execute the gamma correction method provided in the present application.

In the several embodiments provided in the present application, it should be understood that the disclosed apparatus and method can be implemented in other ways. For example, the apparatus embodiments described above are merely illustrative, for example, the division of the units is merely a division of logical functions, and there may be other divisions in actual implementation, for example, multiple units or components can be combined, or can be integrated into another system, or some features can be ignored or not implemented. In addition, the displayed or discussed mutual coupling or direct coupling or communication connection may be indirect coupling or communication connection through some interfaces, apparatuses or units, and may be in electrical, mechanical or other forms.

The units described as separate components may or may not be physically separated, and the components displayed as units may or may not be physical units, that is, may be located in one place, or may be distributed on multiple network units. Some or all of the units may be selected according to actual needs to achieve the objectives of the solutions of the embodiments.

In addition, the functional units in the embodiments of the present application may be integrated into one processing unit, or each unit may exist alone physically, or two or more units may be integrated into one unit. The above-mentioned integrated unit may be implemented in the form of hardware, or may be implemented in the form of hardware plus software functional units.

What is claimed is:

1. A gamma correction method, comprising:
determining a corresponding target binding point at low-grayscale fault for an organic light emitting diode (OLED) module to be corrected according to a preset gamma curve;
determining red, green and blue (RGB) adjustment values corresponding to the target binding point according to RGB measurement values of a previous binding point of the target binding point;
determining voltages of the target binding point according to the RGB measurement values and the RGB adjustment values; and
performing gamma correction on the OLED module to be corrected according to the voltages of the target binding point.

2. The gamma correction method according to claim 1, wherein the determining of the RGB adjustment values corresponding to the target binding point according to the RGB measurement values of the previous binding point of the target binding point comprises:
determining voltages of the previous binding point of the target binding point according to the RGB measurement values;
determining voltage adjustment values corresponding to the target binding point according to a preset voltage and the voltages of the previous binding point; and
determining the RGB adjustment values according to the voltage adjustment values.

3. The gamma correction method according to claim 1, wherein the determining of the voltages of the target binding point according to the RGB measurement values and the RGB adjustment values comprises:
calculating differences between the RGB measurement values and the RGB adjustment values;
determining RGB values of the target binding point according to the differences; and
determining the voltages of the target binding point according to the RGB values of the target binding point.

4. The gamma correction method according to claim 1, wherein before the determining of the corresponding target binding point at the low-grayscale fault for the OLED module to be corrected according to the preset gamma curve, the method further comprises:
obtaining brightness data of the OLED module to be corrected; and
converting the brightness data into pixel data.

5. The gamma correction method according to claim 4, wherein the determining of the corresponding target binding point at the low-grayscale fault for the OLED module to be corrected according to the preset gamma curve, comprising:
determining brightness values of a plurality of binding points corresponding to the OLED module to be corrected according to the preset gamma curve based on the pixel data; and
determining the target binding point according to the brightness values.

6. The gamma correction method according to claim 4, wherein the obtaining of the brightness data of the OLED module to be corrected comprises:
collecting the brightness data through a camera.

7. The gamma correction method according to claim 4, wherein the converting of the brightness data into the pixel data comprises:
inputting the brightness data to a display driver integrated circuit (DDIC) to obtain the pixel data.

8. The gamma correction method according to claim 3, wherein the calculating of the differences between the RGB measurement values and the RGB adjustment values comprises:
calculating the differences through one of following:
linear difference method, nonlinear difference method, exponential difference method, and function difference method.

9. The gamma correction method according to claim 1, wherein the preset gamma curve comprises a G2.2 curve.

10. A non-transitory computer-readable storage medium, storing therein computer instructions which, when executed by a processor, enable the processor to:
determine a corresponding target binding point at low-grayscale fault for an organic light emitting diode (OLED) module to be corrected according to a preset gamma curve;
determine voltages of the target binding point according to the RGB measurement values and the RGB adjustment values; and
perform gamma correction on the OLED module to be corrected according to the voltages of the target binding point.

11. The non-transitory computer-readable storage medium according to claim 10, wherein the computer instructions which, when executed by a processor, further enable the processor to:
determine voltages of the previous binding point of the target binding point according to the RGB measurement values;
determine voltage adjustment values corresponding to the target binding point according to a preset voltage and the voltages of the previous binding point; and
determine the RGB adjustment values according to the voltage adjustment values.

12. The non-transitory computer-readable storage medium according to claim 10, wherein the computer instructions which, when executed by a processor, further enable the processor to:
calculate differences between the RGB measurement values and the RGB adjustment values;
determine RGB values of the target binding point according to the differences; and
determine the voltages of the target binding point according to the RGB values of the target binding point.

13. The non-transitory computer-readable storage medium according to claim 10, wherein the computer instructions which, when executed by a processor, further enable the processor to:
obtain brightness data of the OLED module to be corrected; and
convert the brightness data into pixel data.

14. The non-transitory computer-readable storage medium according to claim 13, wherein the computer instructions which, when executed by a processor, further enable the processor to:
determine brightness values of a plurality of binding points corresponding to the OLED module to be corrected according to the preset gamma curve based on the pixel data; and
determine the target binding point according to the brightness values.

15. The non-transitory computer-readable storage medium according to claim 13, wherein the computer instructions which, when executed by a processor, further enable the processor to:
collect the brightness data through a camera.

16. The non-transitory computer-readable storage medium according to claim 13, wherein the computer instructions which, when executed by a processor, further enable the processor to:
input the brightness data to a display driver integrated circuit (DDIC) to obtain the pixel data.

17. The non-transitory computer-readable storage medium according to claim 12, wherein the computer instructions which, when executed by a processor, further enable the processor to:
calculate the differences through one of following:
linear difference method, nonlinear difference method, exponential difference method, and function difference method.

18. The non-transitory computer-readable storage medium according to claim 10, wherein the preset gamma curve comprises a G2.2 curve.
